(19) United States
(12) Patent Application Publication
(10) Pub. No.: US 2018/0244288 A1
(43) Pub. Date: Aug. 30, 2018

(54) METHODS AND SYSTEMS FOR PROVIDING AUTOMATED ASSISTS OF DRIVING TASK DEMANDS FOR REDUCING DRIVER DROWSINESS

(71) Applicant: GM GLOBAL TECHNOLOGY OPERATIONS LLC, Detroit, MI (US)

(72) Inventors: YI G. GLASER, WEST BLOOMFIELD, MI (US); RAYMOND J. KIEFER, HUNTINGTON WOODS, MI (US); CHARLES A. GREEN, CANTON, MI (US); DANIEL S. GLASER, WEST BLOOMFIELD, MI (US); MICHAEL A. WUERGLER, CLARKSTON, MI (US); DEBBIE NACHTEGALL, ROCHESTER HILLS, MI (US); MAUREEN A. SHORT, GROSS POINT WOODS, MI (US); ERIC L. RAPHAEL, BIRMINGHAM, MI (US)

(73) Assignee: GM GLOBAL TECHNOLOGY OPERATIONS LLC, Detroit, MI (US)

(21) Appl. No.: 15/445,733

(22) Filed: Feb. 28, 2017

(51) Int. Cl. B60W 50/14; B60W 40/08; B60R 11/04

(52) U.S. Cl. CPC B60W 50/14; B60W 40/08; B60R 11/04; B60W 50/16; B60W 2420/52; B60W 2420/54; B60W 2050/143; B60W 2040/0827

(57) ABSTRACT

Methods and systems are provided for responding to drowsiness of a driver. The method and system comprise detecting by a module the drowsiness of the driver based on a detected level exceeding a threshold associated with at least one of a set of conditions of the driver which indicate the drowsiness of the driver. The conditions of driver drowsiness include driver performance, vigilance, judgment and alertness. A response to the conditions which have been detected is provided by assists to the driver to at least facilitate reducing the detected level below the threshold associated with the conditions and any subsequent drowsiness of the driver.

### INTRODUCTION

The present disclosure relates generally to vehicular control systems and, more particularly relates to methods and systems for responding to driver drowsiness by automatically providing driver demand tasks and/or alerts to raise driver awareness.

Vehicle control systems have been devised to determine driver drowsiness conditions by assessing using computer vision technologies driver physical behavior such eye movements and vehicular actions, such as lane violations to make drowsiness determinations. Such vehicle control systems are customarily directed to auditory signals or to initiating steps of automated driver intervention to respond to the driver drowsiness condition upon detection. These do not provide task demands to raise driver awareness levels in response to detections of driver drowsiness.

Accordingly, it is desirable to raise driver awareness and driver arousal levels by providing automated demand tasks. For example, automated altering of a primary vehicle control task may be provided to increase the magnitude of steering inputs required to maintain the vehicle lane position, or increase the amount of accelerator pedal interactions in both magnitude and in frequency needed to maintain a speed. Alternatively, a system may remove or reduce inputs provided by automation or active safety features to increase driver demands.

It is desirable to raise driver arousal levels by providing automated systems to engage the driver in non-visual auditory tasks in a manner that do not interfere with driving. For example, these may include automatically initiating phone calls or prompting the driver with entertainment options because it is often the case drivers engaged in phone conversations or entertainment selections have exhibited greater awareness while conversing or listing to the radio.

It is desirable to provide sophisticated and more effectual multi-task automated types of recommendations rather than the customary auditory or visual recommendations found in current production vehicles where often such customary recommendations are simply for the driver to stop the vehicle and take a break; which many drivers may find unacceptable due to trip delays and/or their desire to quickly reach a destination.

It is desirable to prevent driver drowsiness by continuously monitoring and providing feedback of drowsiness levels to the driver so the driver can assess whether these levels are improving and potentially receive, either automatically or via driver request, more intensive drowsy driver assist tasks.

It is desirable to send a notification to contact a second party such as a passenger, remote operator and/or family member, to help the driver combat drowsiness and/or develop a plan to cease driving until appropriate arousal levels can be obtained.

Additionally, it is desirable for drivers to have the option to preset their preferred drowsy driver assist countermeasures and once a pre-determined or perhaps driver-selected drowsiness levels have been reached, and before any of the countermeasure is actually applied, the driver having the option to cancel the countermeasures.

Furthermore, other desirable features and characteristics of the present invention will become apparent from the subsequent detailed description of the invention and the appended claims, taken in conjunction with the accompanying drawings and the background of the invention.

### SUMMARY

A method is provided for responding to drowsiness of a driver. The method comprises detecting, by a module, the drowsiness based on a detected level exceeding a threshold associated with at least one of a set of conditions of the driver which indicate the drowsiness of driver. The conditions comprise driver performance, vigilance, judgment and alertness. A response to the conditions which have been detected is provided by assists to the driver to at least facilitate reducing the detected level below the threshold associated with the conditions and any subsequent drowsiness associated therewith.

A system is provided for responding to drowsiness of a driver. The system comprises at least one processor; and at least one computer-readable storage device comprising instructions that when executed causes performance of a method for providing countermeasures for driver drowsiness. The method comprises determining, using information provided by one or more sensors of a vehicle, a level exceeding a threshold for a condition associated with driver drowsiness. The information provided by the sensors is of driver performance, vigilance, judgement or alertness with respect to vehicle operations, and a response to the condition associated with driver drowsiness is provided by a plurality of countermeasures to facilitate reducing the level below the threshold for the condition of driver drowsiness. The countermeasures comprise a plurality of passive, interactive and external vehicle assists.

### BRIEF DESCRIPTION OF THE DRAWINGS

The present invention will hereinafter be described in conjunction with the following drawing figures, wherein like numerals denote like elements, and

FIG. 1 is a functional block diagram of a vehicle that includes a control module that can be implemented in connection with a vehicle arousal system, in accordance with an exemplary embodiment;

FIG. 2 is a functional block diagram of the vehicle arousal system, in accordance with an exemplary embodiment;

FIG. 3 is a functional block diagram of a selection and prioritization module that can be implemented in connection with a vehicle arousal system, in accordance with an exemplary embodiment;

FIG. 4 is a flowchart of a process for providing notifications on a camera display for a vehicle, and that can be implemented in connection with the vehicle arousal system of FIG. 2, in accordance with an exemplary embodiment; and

FIG. 5 is a functional block diagram of the drowsiness detector module that can be implemented in connection with the vehicle arousal system, in accordance with an exemplary embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

The present disclosure describes a driver arousal system that provides a multitude of assists for preventing driver drowsiness and for arousing a driver if driver drowsiness is detected where the assists include passive, non-passive and external assists.

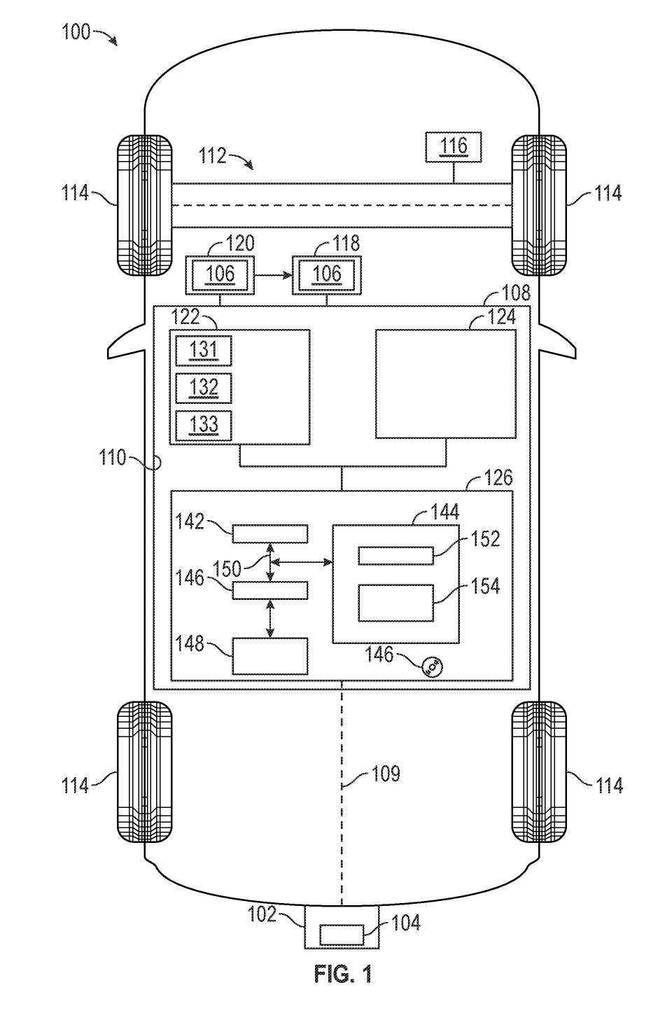

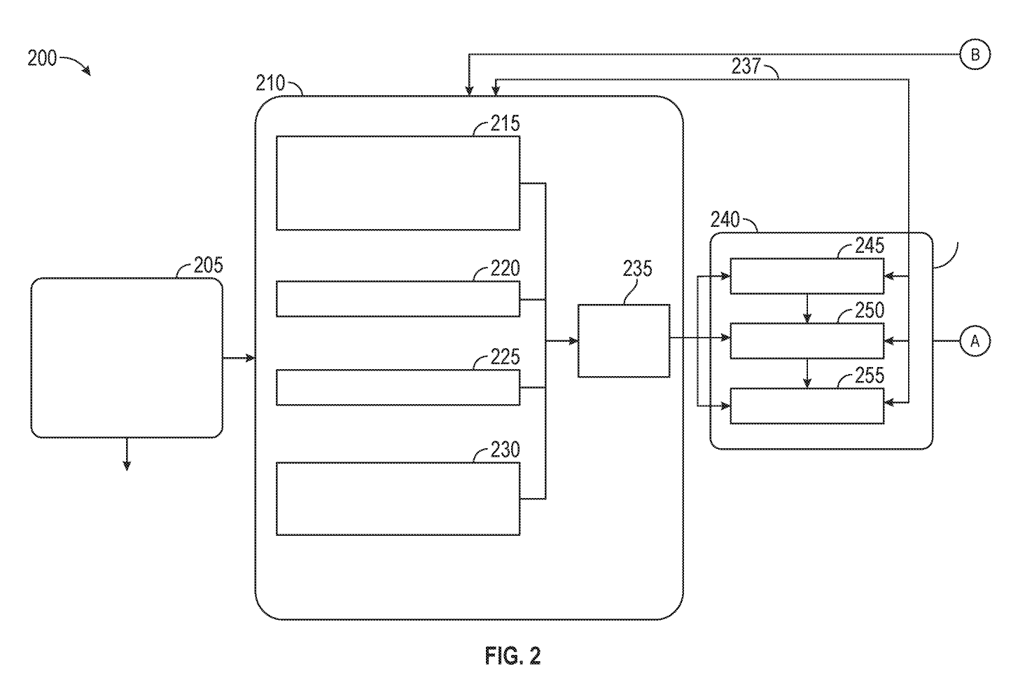

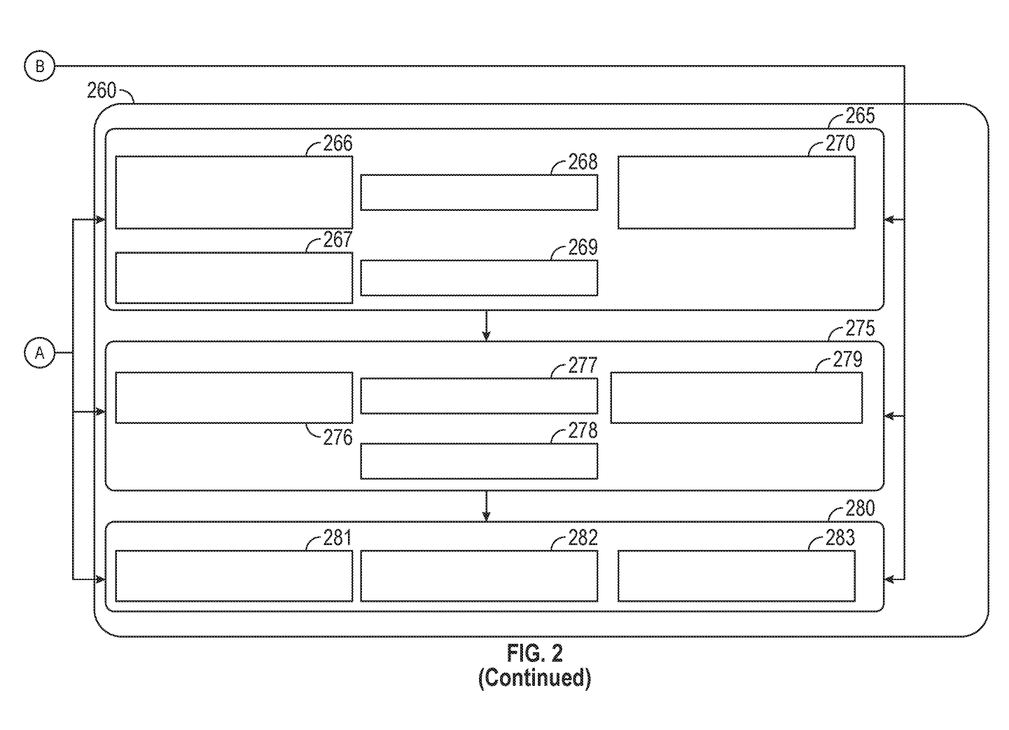

As depicted in FIG. 1, FIG. 1 illustrates a vehicle 100, according to an exemplary embodiment for incorporating a vehicle arousal system. As described in greater detail further below, the vehicle 100 includes a camera 102 that is disposed in the interior of a body 110 of the vehicle 100 and provides images of the driver. The camera 102 is controlled via a control system 108, as depicted in FIG. 1. In various embodiments, the control system 108 provides a notification along with processed images provided by the camera 102, in which the notification is provided as part of a fixed region of a display image generated from the processed images, for aid in detection of driver drowsiness for example and as discussed further below in connection with FIG. 1 as well as FIGS. 2-5.

The vehicle 100 preferably comprises an automobile. The vehicle 100 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In certain embodiments, the vehicle 100 may also comprise a motorcycle or other vehicle, or other system having a camera image with a fixed referenced point.

The vehicle 100 includes the above-referenced body 110 that is arranged on a chassis 112. The body 110 substantially encloses other components of the vehicle 100. The body 110 and the chassis 112 may jointly form a frame. The vehicle 100 also includes a plurality of wheels 114. The wheels 114 are each rotationally coupled to the chassis 112 near a respective corner of the body 110 to facilitate movement of the vehicle 100. In one embodiment, the vehicle 100 includes four wheels 114, although this may vary in other embodiments (for example for trucks and certain other vehicles).

A drive system 116 is mounted on the chassis 112, and drives the wheels 114. The drive system 116 preferably comprises a propulsion system. In certain exemplary embodiments, the drive system 116 comprises an internal combustion engine and/or an electric motor/generator, coupled with a transmission thereof. In certain embodiments, the drive system 116 may vary, and/or two or more drive systems 116 may be used. By way of example, the vehicle 100 may also incorporate any one of, or combination of, a number of different types of propulsion systems, such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, a combustion/electric motor hybrid engine, and an electric motor.

As depicted in FIG. 1, the camera 102 with lens 104 is disposed within interior of the body 110 of the vehicle 100. In the depicted embodiment, the camera 102 is coupled to the control system 108 of the vehicle 100, as shown in FIG. 1. It will be appreciated that this may vary in certain embodiments. For example, in the depicted embodiment, the camera 102 is a passenger facing camera disposed with a field of view of the driver in an interior location portion of the vehicle 100, in other embodiments, the camera 102 may be mounted on a passenger's side, driver's side, or elsewhere in the interior or on the body 110 of the vehicle 100 (e.g. in front of the vehicle 100, on a windshield or grille of the vehicle 100, and so on).

The camera 102 provides images of the driver inside the vehicle 100 which may include driver facial features, driver posture, driver movements etc. for processing by a driver arousal system.

The control system 108 may control operation of the camera 102 and the displays 106. The control system 108 is disposed within the body 110 of the vehicle 100. In one embodiment, the control system 108 is mounted on the chassis 112. Among other control features, the control system 108 obtains images from the camera 102, processes the images, locally, remotely, or a combination of both by various processors 142. In various embodiments, the control system 108 provides these and other functions in accordance with steps of the vehicle arousal system described further below in connection with FIGS. 2-5. In certain embodiments, the control system 108 may be disposed outside the body 110, for example on a remote server, in the cloud, or in a remote smart phone or other device where image processing is performed remotely.

Also as depicted in FIG. 1, in various embodiments the control system 108 is coupled to the camera 102 via a communication link 109, and receives camera images from the camera 102 via the communication link 109. In certain embodiments, the communication link 109 comprises one or more wired connections, such as one or more cables (e.g. coaxial cables and/or one or more other types of cables), and/or one or more wireless connections (e.g. using wireless bus technology).

As depicted in FIG. 1, the control system 108 includes a sensor array 122 and a controller 126. Also as depicted in FIG. 1, in certain embodiments the control system 108 also includes a transceiver 124. In certain embodiments, the images from the camera 102 may be received by the control system 108 via one or more transceivers 124 and/or components thereof (e.g. a receiver).

The sensor array 122 includes one or more sensors that provide object detection for the vehicle 100. Specifically, in various embodiments, the senor array 122 includes one or more radar sensors 131, LIDAR sensors 132, sonar sensors 133 and/or other object detection sensors that allow the control system 108 to identify and track the position and movement of moving vehicles, other vehicles, and other objects in proximity to the vehicle 100. In addition, in certain embodiments, the sensor array 122 may also include certain additional sensor(s) that may provide vehicle speed (e.g. to determine whether or not the vehicle 100 is moving, and the trajectory and direction of movement), along with for example using one or more-wheel speed sensors or accelerometers, among other possible sensors and/or related devices and/or systems.

In one embodiment, the controller 126 is coupled to the camera 102, the displays 106, the sensor array 122, and the transceiver 124. Also in one embodiment, the controller 126 is disposed within the control system 108, within the vehicle 100. In certain embodiments, the controller 126 (and/or components thereof, such as the processor 142 and/or other components) may be part of the camera 102, disposed within the camera 102, and/or disposed proximate to the camera 102. Also in certain embodiments, the controller 126 may be disposed in one or more other locations of the vehicle 100. In addition, in certain embodiments, multiple controllers 126 may be utilized (e.g. one controller 126 within the vehicle 100 and another controller within the camera 102), among other possible variations. In addition, in certain embodiments, the controller can be placed outside vehicle, such as in a remote server, in the cloud or on a remote smart device.

As depicted in FIG. 1, the controller 126 comprises a computer system for processing among things applications related to a driver arousal system. In certain embodiments, the controller 126 may also include one or more of the sensors of the sensor array 122, the transceiver 124 and/or components thereof, the camera 102 and/or components thereof, one or more displays 106 and/or components thereof, and/or one or more other devices and/or systems and/or components thereof. In addition, it will be appreciated that the controller 126 may otherwise differ from the embodiment depicted in FIG. 1. For example, the controller 126 may be coupled to or may otherwise utilize one or more remote computer systems and/or other control systems, for example as part of one or more of the above-identified vehicle 100 devices and systems.

In the depicted embodiment, the computer system of the controller 126 includes a processor 142, a memory 144, an interface 146, a storage device 148, and a bus 150. The processor 142 performs the computation and control functions of the controller 126, and may comprise any type of processor or multiple processors, single integrated circuits such as a microprocessor, or any suitable number of integrated circuit devices and/or circuit boards working in cooperation to accomplish the functions of a processing unit. During operation, the processor 142 executes one or more programs 152 contained within the memory 144 and, as such, controls the general operation of the controller 126 and the computer system of the controller 126, generally in executing the processes described herein, such as the processes of the drowsiness detection module and multi-assist module described further below in connection with FIGS. 2-5.

The memory 144 can be any type of suitable memory. For example, the memory 144 may include various types of dynamic random access memory (DRAM) such as SDRAM, the various types of static RAM (SRAM), and the various types of non-volatile memory (PROM, EPROM, and flash). In certain examples, the memory 144 is located on and/or co-located on the same computer chip as the processor 142. In the depicted embodiment, the memory 144 stores the above-referenced program 152 along with one or more stored values 154.

The bus 150 serves to transmit programs, data, status and other information or signals between the various components of the computer system of the controller 126. The interface 146 allows communication to the computer system of the controller 126, for example from a system driver and/or another computer system, and can be implemented using any suitable method and apparatus. In one embodiment, the interface 146 obtains the various data from the sensors of the sensor array 122 and/or the transceiver 124. The interface 146 can include one or more network interfaces to communicate with other systems or components. The interface 146 may also include one or more network interfaces to communicate with technicians, and/or one or more storage interfaces to connect to storage apparatuses, such as the storage device 148.

The storage device 148 can be any suitable type of storage apparatus, including direct access storage devices such as hard disk drives, flash systems, floppy disk drives and optical disk drives. In one exemplary embodiment, the storage device 148 comprises a program product from which memory 144 can receive a program 152 that executes one or more embodiments of one or more processes of the present disclosure, such as the steps of the vehicle arousal system (and any sub-processes thereof) described further below in connection with FIGS. 2-5. In another exemplary embodiment, the program product may be directly stored in and/or otherwise accessed by the memory 144 and/or a disk (e.g., disk 156), such as that referenced below.

The bus 150 can be any suitable physical or logical means of connecting computer systems and components. This includes, but is not limited to, direct hard-wired connections, fiber optics, infrared and wireless bus technologies. During operation, the program 152 is stored in the memory 144 and executed by the processor 142.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 142) to perform and execute the program. Such a program product may take a variety of forms, and the present disclosure applies equally regardless of the particular type of computer-readable signal bearing media used to carry out the distribution. Examples of signal bearing media include: recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 126 may also otherwise differ from the embodiment depicted in FIG. 1, for example in that the computer system of the controller 126 may be coupled to or may otherwise utilize one or more remote computer systems and/or other control systems.

As depicted in FIG. 2, the vehicle arousal system 200 may be expressed in segmented stages consisting of an initial setup stage prior to initiating the vehicle arousal system 200, an intermediary stage of the vehicle arousal system 200 for detecting and monitoring the driver for drowsiness when appropriate thresholds are reached; and a later stage of the vehicle arousal system 200 for alerting the driver of drowsiness by a multitude of alert types and initiating an arousal mechanism comprising of passive, non-passive and external assists to lessen or remedy the driver drowsiness.

With continued reference to FIG. 2 with respect to the vehicle arousal system 200, an initial set-up of a series of types of alerts may be manually entered by the driver at alert module 205. In an alternate mode of operation, the alerts may be prior programmed with defaults generally gained from data from empirical testing of alerts with drivers. Additionally, more sophisticated set-ups may be entered by an automated accessing of a driver profile information from mobile devices such as phones, tablets, key FOB, wearables etc. In instances, a driver may create a profile or may simply link to profiles or profile information already created by communicating with a cloud server directly or indirectly to obtain profile information. For example, such profile information could be associated with email accounts, artificial intelligence AI apps, GPS data, etc. Additionally, given the plethora of apps that are becoming more personalized, sleep information, medical information and other health information of the driver can easily be linked with the driver consent. Also, other family members or drivers, as well as prior statistical information of driving populations and sleepiness conditions while driving in certain routes, times of the day, dates of a year, can also be used to glean data of likelihood of driver drowsiness and added to profiles or alert data.

An exemplary embodiment of a cloud based data repositories which may be accessed and associated with a driver is a driver's telematics system account or the like for providing information to be used in the alert set-up. In other instances, the initial set-up may be tied to a multitude of data sources that allow for personalization with the associated data. In addition, the set-up may have dynamic as well as static qualities, for example in an exemplary embodiment, the driver may allow for manual updates or changes of the set-up. Also, automated changes could be easily added allowing for alerts to be constantly changing which in instances may in fact raise the efficacy of the alerts simply by in turn raising driver interest by a change or driver likeness to the alert. Alternately, alerts could be based on much of the driver's own personal qualities and attributes; for example, drivers with hearing losses may require audio alerts of higher magnitude or may be more sensitive to haptic alerts. In any event, the alert module 205 would have a flexible architecture that can allows for multiple of set-ups including defaults and personalization.

In an exemplary embodiment as illustrated in the alert module 205, the alert level may comprise 4 different settings of a setting 1, setting 2, setting 3 and setting 4 as follows: setting 1 of “an alert”; setting 2 of “an alert +passive alert”; setting 3 of “an alert+passive alert+interactive assist”; and setting 4 of “an alert+passive alert+vehicle interactive+external assist”. Passive alerts may be considered alerts not requiring driver intervention or actions, that is automated alerts such as auditory alerts, subliminal and non-subliminal cues, visual alerts such as flashing of interior lights, comfort setting changes like temperature, radio settings, seat belt changes, seat position changes, information presented on localities such as restaurants, hotels etc. In an exemplary embodiment, smart seat belt technologies can be integrated creating an “arousal” stimulus to the driver such as tugging or tightening and loosening of the seat belt across the driver. More caustic passive alerts can be applied like heat/cold changes to the car seats, automated massage operations of the driver seat and even mild pain creating applications are feasible to stimulate the driver.

The alert module 205 may provide data of alerts and related notifications to a drowsiness detection module 210. In an exemplary embodiment, the drowsiness detection module 210 receives the data from the alert module 205 for further analysis and determinations using a set of modules having multiple processors for a distributed processing arrangement of the alert data fed. For example, the multiple modules performing the data processing may be arranged in parallel or in series or in combination of both for executing the processing steps and may consist of a set of modules of a driver performance module 215 for assessing driving performance, a vigilance module 220 for assessing surroundings of objects, roadway and other vehicle traffic, a judgment module 225 for assessing driver judgment related abilities, and an alertness module 230 for assessing driver visual or the like sensory abilities or impairments.

The driver performance module 215 may ascertain the driver's ability to drive by using, among other things, computer vision tools and cameras and other sensors to determine whether the driver exhibits signs of driver impairment by vehicle-based measurements. For example, the driver performance module 215 may monitor a number of metrics when driving, including deviations from lane position, movement of the steering wheel, pressure on the acceleration pedal, unduly amount of pressure on braking continuously and whether there is any change in these monitored metrics that crosses a specified threshold which may indicate a significant increased impairment and probability that the driver is drowsy. With respect to vigilance problems, the vigilance module 220 may assess a state of vigilance of surroundings characterized by other vehicles, road surface, obstacles, environment etc.

The judgment module 225 may assess driver judgments, examples of which may include direct and indirect driver behaviors like lateral positions, steering wheel movements, and time to line crossing. The alertness module 230 may assess driver alertness. The alertness module 230 may monitor driver vitals and driver behavior for assessing driver alertness characteristics. In some instances, the driver may wear a wearable device such as wristband for sensor data communications to the alertness module 230 in order to measure driver vitals like pulse and heart rate for abnormalities or deviations from a given baseline. Additionally, driver behavior actions may be recognized by the alertness module 230 which may include visual characteristics observable from images of the driver of reduced alertness levels such as longer blink duration, slow eyelid movement, smaller degree of eye opening or even closed eyes, frequent nodding, yawning, gaze or narrowness in a line of sight, sluggish facial expression, and drooping posture. Such behavior data may be derived from computer vision techniques which are communicated to the alertness module 230 for monitoring in a non-intrusive manner by a camera viewing the driver.

The data processed by these modules are further weighed against a threshold at a threshold module 235 which is configured in manner to receive by multi-path the data outputted directly from each of the modules; the driver performance module 215, vigilance module 220, the judgment module 225, and the alertness module 230 for assessment by various algorithmic solutions according to particular thresholds which instances may be adjustable according to the driver profiles or other factors to make determinations when to signal a triggering mechanism to trigger a series of alerts of drowsiness to a multi-alert module 240. Multi-alert module 240 comprises a series of alerts that may be triggered individually or in combination of a visual alert module 245, an auditory alert module 250, and a haptic alert 255. The triggering mechanism may include a feedback path 237 that once the threshold of threshold module 235 has been met, with a preset time delay of approximately 3 minutes, the threshold is again re-checked at the threshold module 235 to ensure that the threshold is still met and then a triggering signal is generated to the multi-alert module 240. In other words, a drowsiness state of the driver must be for a given period which is adjustable but prevents false alerts and a more robust alert triggering mechanism for driver drowsiness by a two-step confirmation process. In an exemplary embodiment, after a 3-minute duration period, in a first cycle, a first type of alert of an auditory alert from the auditory alert module 250 may be sounded, followed in a second cycle, after another 3-minute or similar duration, a second type of alert of a haptic alert 255 from a haptic module may be initiated.

The cycles of alerts can be repeated and may be escalated with shorter durations between cycles, increases of magnitude of each type of alert of the auditory, visual, and haptic alerts and further the escalation may follow a priority pattern. For example, the priority of the alerts may begin with the visual alert, followed by the auditory alert and then by the haptic alert. Additionally, the priority may also be based on the type of driver drowsiness sensed by each of the modules; for example, in instances of alerts which are triggered by data generated by the driver performance module 215, a haptic alert 255 may prove to be more efficacious and hence may be prioritized in the alert cycle for triggering.

In response to input from the multi-alert module 240, a multi-assist module 260 coupled to the multi-alert module 240 may instigate countermeasures of assists from sets of groups of assist types of (a) a set of passive type assists generated from a passive assist module 265, (b) a set of in-vehicle interactive types of assists generated from an in-vehicle interactive assist module 275, and (c) a set of external assists generated from an external assist module 280. The countermeasure of passive assists are tasks or demands which do not require a driver response but provide stimuli to increase driver awareness. The passive assist module 265 may further generate a series of passive assists. In particular, passive assists of cues from a cue module 266 which may include subliminal auditory or visual cues. Some common examples of such cues are auditory noises such as those found in high pitch dog whistles, and flashing infrared IR lights. Additionally, a passive assist from a flashing light module 268 for flashing interior vehicle lights may be used to assist in arousing the driver. A comfort setting module 270 for providing passive assists that may lower the interior temperature of the vehicle or change the radio station to cause driver discomfort can be used. Also, providing location information by passive assists linked to the vehicle GPS mapping functions or even by linking to the driver cell phone can provide locations of rest stops or retail shops by a location assist module 267 for convenient venues for the driver to take a break, rest, nourishment etc. to assisting to arouse the driver. In addition, a passive seatbelt module 269 may generate passive assists by providing signals to trigger mechanisms associated with the vehicle that enable automate tugs on the driver seat belt arousing the driver.

In addition to the passive assists laid out, non-passive assists can also be instigated. In particular, referring to in-vehicle interactive assist module 275 a series of non-passive which require driver interaction or intervention may be commenced. In other words, non-passive assists ask for or demand a response from the driver which in turn by virtue of the driver responsive movement, talk, etc. attempts to create “arouse” stimuli raise the driver awareness. For example, a primary vehicle control module 276 can increase the workload demands of the driver associated with controlling the vehicle. In an exemplary embodiment, the primary vehicle control module 276 may adjust the vehicle steering parameters which may result in requiring a driver to engage in more frequent input so as to maintain a lane position.

Alternate embodiments may adjust the vehicle speed parameters so as to make it more difficult for the driver to maintain a constant rate of speed. In other words, the primary vehicle control module 276 may be integrated into the driving operation of the vehicle and in instances unbeknownst to the driver, seamlessly force the drive to exert more energies to continue driving thereby providing stimuli to arouse the driver. In addition, or alternately, driver arousal may be increased by engaging the driver in driving tasks initiated by displaying information and entertainment “infotainment” pop-up messages or telematics systems voice prompting of such oriented interest stimulating messages from an audible question module 277 or similarly other non-visual secondary task from a non-visual secondary task module 279. For example, a prompt could indicate that the driver has been detected being drowsy, and that drowsy driver assist tasks will be initiated to support the driver in increasing their arousal levels.

Additionally, telematics based calls may also be initiated from a telematics based module 278. For example, the telematics based module 278 may be configured with contact data to initiate automatically phone calls to families and friends. This would serve as a convenient way to engage the driver in conversations with families and friends to again provide “arouse” stimuli to raise the driver awareness.

In some instances, the in-vehicle interactive assist module 275 may cross-over and make available a host of external assists from the external assist module 280. For example, the external assist module 280 may be configured to operate in conjunction with the telematics based module 278 which using a telematics-based providers including consumer telematics operators, commercial fleet operators etc. initiates a call with services and parties designated to intervene of the external assist module 280. In particular, the external assist module 280 may include from a ride share module 287 alternate external transportation options which the driver can avail, by an automated calling of ride services such as app services taxi services etc. Other information for driver arousal that may be made available or used in combination with the external assist module 280 for assists may come from external sources (as well as internal sources) that could include topics such as a review of personal planning information, calendars dates and reminders, review or search for and answers of queries of a drive, a trip, the traffic and the road status information, such as an upcoming coffee shop, mile marker, their current road, next exit, current speed limit, debris, construction zones, fuel and police stations, closest vehicle, vehicle ahead; Entertainment topics such as radio, jokes, podcasts, and brain teaser games; a review or search for and answer of queries of vehicle health information, such as oil pressure, upcoming maintenance needs.

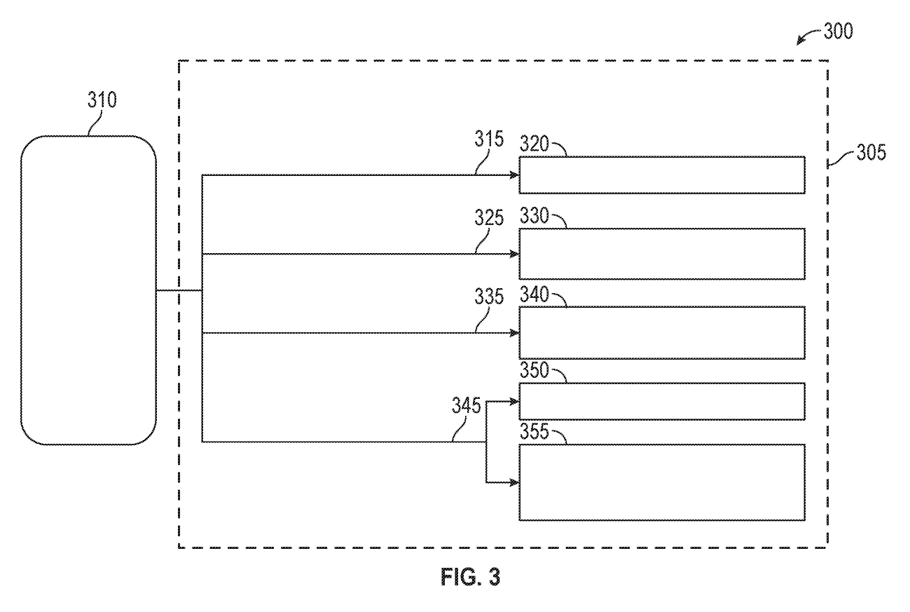

As depicted in FIG. 3, a context sensing and monitoring system 300 is illustrated where a context sensing and monitoring module 310 is incorporated in communication with the passive assist module 305. The context sensing and monitoring module 310 provides additional information such as GPS data, camera images for enabling the passive assist module to better select and prioritize the passive assists to execute. For example, each of the passive assists may be conditionally executed based on a context senses or monitored. In an exemplary embodiment, several conditional responses may be pre-set as follows: in a first case, if at task 315 an external dark condition is sensed, then a flash interior light assist at 320 is executed; in a second case, if at task 325 a condition of a rest stop or coffee shop is monitored to be near then an assist of the nearby monitored rest stop or coffee shop is recommended at 330; in the third case, if at task 335 a condition of a particular radio is monitored to be “ON’, then an assist of a comfort adapt settings change in the volume or radio station is executed at 340; and finally, if at task 345 no conditions are sensed or monitor, then a default assist such as tug of a seat belt at 350 or subliminal or auditory cue at 355 is executed. In other words, each of the assists is conditionally executed and further may also be prioritized in a certain order depending on context of the conditions monitored and sensed by the context sensing and monitoring module 310.

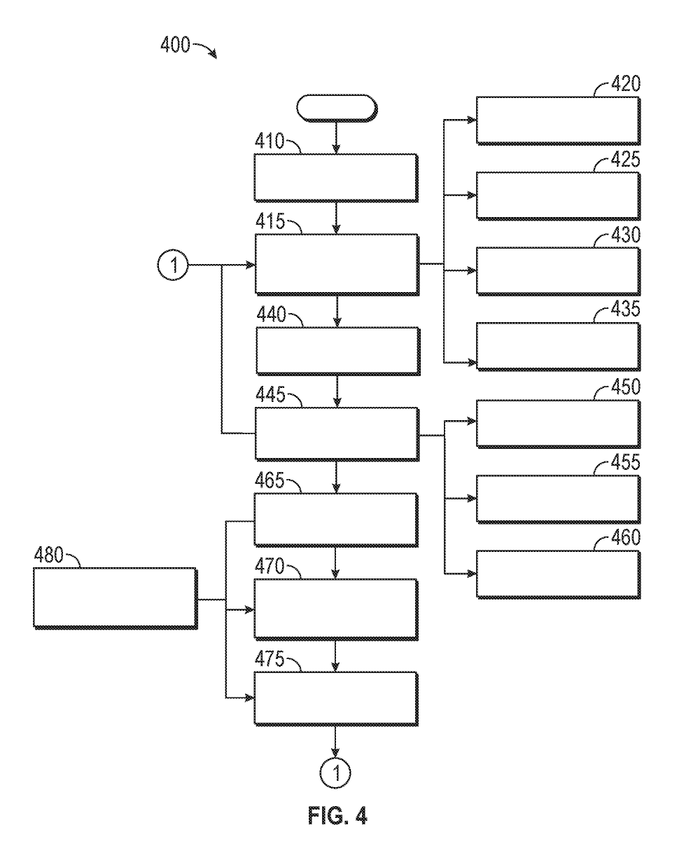

As depicted in FIG. 4, is a flowchart of an operation of the driver arousal system 400. Initially, at step 410, a driver sets alerts by selecting alerts or customizing a set of alerts. If not, the alerts are set to defaults. Next, at step 415, usually when a driver turns on the vehicle and/or an ignition by turning a key, engaging a key fob or start button, and so on the vehicle is started, the driver is then monitored in an approximate immediate manner for driver drowsiness conditions and a set of detections is initiated for detecting and monitoring the driver. Combinations of algorithmic solutions are processed for data acquired in step 420 for driver performance, in step 425 for vigilance problems detections, in step 430 for discerning judgment problems and in step 435 for assessing driver alertness. If thresholds are met in step 440 of the processed data than alerts may be triggered in step 445. Alternately, a delay may be integrated prior to triggering an alert in step 445 when the flow reverts back to step 415 to continue detection and monitoring of drivers for a period and if the threshold in step 440 is still met or exceeded then may trigger the alerts in step 445. This feedback process of monitoring and detecting driver drowsiness for a preset period ensures that false alerts in step 445 are not triggered. In step 445, the alerts triggered are of individual or combination of the alerts found in step 450 of a visual alert, in step 445 of an auditory alert and in step 460 of a haptic alert. Additionally, the alerts in step 445 may operate in conjunction with step 480 of the context sensing and monitoring. In other words, a response to the alert may be triggered and a series of assists are executed in step 465 of passive assists, in step 470 of in-vehicle interactive assists, and in step 475 of external assists in attempt to counter act and remedy the driver drowsiness condition detected in step 415.

As previously mentioned, the passive assist in step 465, the in-vehicle interactive assist in step 470 and the external assist in 475 operate in conjunction with the context sensing and monitoring in step 480 to increase the efficacy of the assists by providing context data for better selection and prioritization of the different passive, interactive, and external assists. In addition, after cycling through a selection or prioritization of a singular assist; of multiples of similar passive, interactive or external assists; or of combinations across the different types of assists in steps 465, 470, 475 the flow reverts to step 415 to re-assess the impact of the selected assist or assists on the detected driver drowsiness condition. If the monitored or detected driver drowsiness condition are diminished or extinguished, then no the flow remains in a detecting and monitoring mode at step 415 until the threshold in step 440 is met. Otherwise, if the monitored and detected drowsiness condition is unchanged or in fact increased, then the flow continues and additional alerts in step 445 are executed and additional assists in steps 465, 470, and 475 may also be executed. Further, in exemplary embodiments, the alerts in step 445 or passive assists in step 465 may be bypassed and escalations of the countermeasures applied relying on more non-passive actions of the interactive assists in step 470 and external assists in step 475. That is, if the driver drowsiness condition is unresponsive to an initial set of assists, the feedback process of detection and monitoring in step 415 may result in changes to the alert and assist scheme and a feedback process of a different alert or assist combination in further attempts to diminish the drivers' drowsiness state. Hence, the driver arousal system 400 flow includes several feedback loops to inter-mix different alerts and assists to improve efficacy when counteracting a driver drowsiness condition.

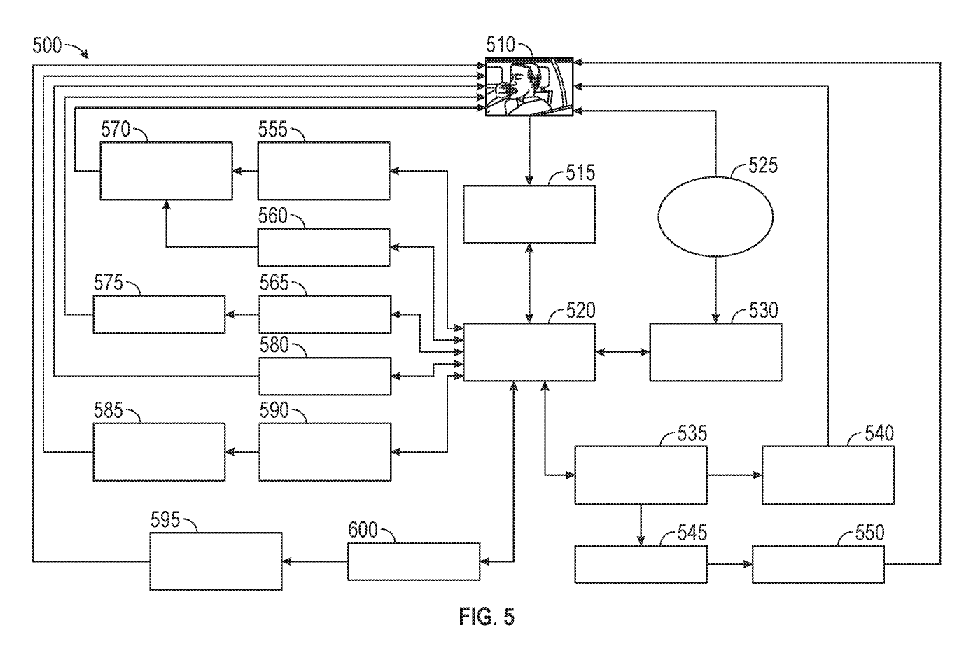

As depicted in FIG. 5, a block diagram of the driver drowsiness system 500 is illustrated of the driver 510, the drowsiness detector 515 and the vehicle data bus 520 interconnections with the other vehicle modules. The vehicle data bus 520 serves as the main data bus to which all the data is exchanged between the various interconnected modules. In particular, the modules that are directly linked to the vehicle data bus 520 are the instrument panel cluster 555, the infotainment 560, the ON-STAR® telematics 565, the heating, ventilation and air conditioning HVAC module 580, the power train control 590, the external object calculating module EOCM 600, the body control module 535, and the electric power steering module 530.

In addition, the visual displays 570 are viewed by the driver 510 of data of the infotainment 560 and instrument panel cluster 555 and audio/speakers 575 listened to by the driver 510 are coupled to the ON-STAR® telematics 565. The accelerator pedals 585 which is actuated by the driver 510 is coupled to the power train control 590, and likewise is a steering wheel 525 actuated by the driver 510 coupled to the electric power steering module 530. The drivers' actuation and usage of the accelerator pedal 585, viewing of the instrument clusters, and steering of the electric power steering module 530 provide generate data for detection by the drowsiness detector 515 which is interconnected to the data stream via the vehicle data bus 520 and is configured to receive the data from these drivers operated devices permitting the drowsiness detector to glean information of the driver actions and from which assess the drowsiness condition of the driver.

Additionally, the drowsiness detector 515 is coupled to the body control module 535 allowing the drowsiness detector to send control signals to generate passive assists to the driver. Likewise, the drowsiness detector 515 is coupled via the vehicle data bus 520 to the ON-STAR® telematics 565, the infotainment 560 and power train control 590 allowing for control signals to be sent for passive, interactive, and external assists to be generated that employ these devices in the various assists. In other words, the interconnection by the vehicle data bus enables control signals as well data to be received in by the drowsiness detector for the monitoring and detection and to activate and adjust the various devices that are used to cause the passive and non-passive assists such as flashing interior lights of interior lighting module 540, haptic 550 alerts of the seat module 545, tugging of seat belts caused by the motorized seat belt module 595 etc.

Once a pre-determined or perhaps a driver-selected drowsiness levels are reached, and before any countermeasure are applied, the driver 510 may be provided an opportunity to cancel the countermeasure within a short period by a manual or voice input, otherwise the countermeasures will begin to initiate once the allowed time runs out. In order to avoid undesired countermeasures, the driver 510 would need to provide the input in a timely manner, which may additionally increase the arousal level as the driver 510 would have to recognize to take responsive actions within a particular time period.

Additionally, once pre-determined or when driver-selected drowsiness levels are reached, a driver 510 may be provided continuous feedback information on their drowsiness level determined via the vehicle and/or wearable devices (not shown) coupled to the vehicle data bus 520 or not. If the drowsy driver assists task(s) initiated are not sufficiently increasing arousal levels as monitored by various vehicle sensors, either via by making driver request (e.g., based on monitoring feedback) or via automatic detection by the system, these tasks may be changed or altered in a way in an attempt to further increase driver arousal levels.

Once high levels of driver drowsiness are detected, a notification could be sent to a second party (or parties), such as family, friends, a telematics-based operator, and/or fleet (e.g. Commercial truck) operator. The second party could then contact the driver to help the driver combat drowsiness, and/or assist the driver with a plan to ensure they do not continue driving drowsy (e.g., taking a nap, stopping for a coffee, second part could pick up the driver, or phoning a taxi).

While at least one exemplary aspect has been presented in the foregoing detailed description of the invention, it should be appreciated that a vast number of variations exist. It should also be appreciated that the exemplary aspect or exemplary aspects are only examples, and are not intended to limit the scope, applicability, or configuration of the invention in any way. Rather, the foregoing detailed description will provide those skilled in the art with a convenient road map for implementing an exemplary aspect of the invention. It being understood that various changes may be made in the function and arrangement of elements described in an exemplary aspect without departing from the scope of the invention as set forth in the appended claims.

1. A method for responding to drowsiness of a driver, the method comprising:
detecting, by a module, the drowsiness based on a detected level exceeding a threshold associated with at least one of a set of conditions of the driver which indicate the drowsiness of the driver, the conditions comprise driver performance, vigilance, judgment and alertness; and
responding to the conditions which have been detected by providing assists to the driver to at least facilitate reducing the detected level below the threshold associated with the conditions and any subsequent drowsiness associated therewith wherein the assists comprise a plurality of tasks which are automated tasks which comprise: passive, interactive and external assists for providing countermeasures to reduce the detected level of the condition of drowsiness.

2. (canceled)

3. The method of claim 1, wherein in a next responding step: the method further comprises:
escalating a response, if the detected level either increases or is not reduced of the condition associated with the drowsiness of the driver by selecting another assist or a combination of assists from a plurality of assists comprising passive assists, interactive assists and external assists.

4. The method of claim 2, wherein the passive assists further comprise tasks not requiring a response on the part of the driver in an attempt to at least facilitate reducing the detected level of conditions of driver drowsiness.

5. The method of claim 2, wherein the passive assists comprise notifications sent to the driver which further comprise: a subliminal or auditory cue, a flashing of an interior light, a comfort setting change, information about localities, and a driver seatbelt action.

6. The method of claim 2, wherein the interactive assists comprise tasks requiring a response on the part of the driver in an attempt to at least facilitate reducing the detected level of conditions of driver drowsiness.

7. The method of claim 2, wherein the interactive assists comprise tasks of the driver which requiring a response which further comprise: altering a primary control of the vehicle, posing an audible question, requiring a secondary task, and using phone calling features.

8. The method of claim 2, wherein the external assists comprise tasks requiring a response on the part of the driver to converse with third parties for assistance or intervention, in an attempt by communications with the driver either, to at least facilitate reducing the detected level of the condition of driver drowsiness or to intercede in a driving activity.

9. A computer program product tangibly embodied in a non-transitory computer-readable storage device and comprising instructions that when executed by a processing module perform a method for responding to conditions of driver drowsiness, the method comprising:
detecting, by a processing module, the drowsiness based on a detected level exceeding a threshold associated with at least one of a set of conditions of the driver which indicate the drowsiness of the driver, the conditions comprise driver performance, vigilance, judgment and alertness; and
responding to the conditions which have been detected by providing assists to the driver to at least facilitate reducing the detected level below the threshold associated with the conditions and any subsequent drowsiness associated therewith wherein the assists are a plurality of tasks which are automated tasks which comprise: passive, interactive and external assists for providing countermeasures to reduce the detected level of the condition of drowsiness.

10. (canceled)

11. The method of claim 9, wherein in a next responding step: the method further comprises:
escalating a response, if the detected level either increases or is not reduced of the condition associated with the drowsiness of the driver by selecting another assist or a combination of assists from a plurality of assists comprising passive assists, interactive assists and external assists.

12. The method of claim 10, wherein the passive assists further comprise tasks not requiring a responsive action on the part of the driver in an attempt to reduce the detected level of conditions of driver drowsiness.

13. The method of claim 10, wherein the passive assists comprise notifications sent to the driver which further comprise: a subliminal or auditory cue, a flashing of an interior light, a comfort setting change, information of localities, and a driver seatbelt action.

14. The method of claim 10, wherein the interactive assists comprise tasks requiring a responsive action on the part of the driver in an attempt to reduce the detected level of conditions of driver drowsiness.

15. The method of claim 10, wherein the interactive assists comprise tasks requiring a responsive action which further comprise: altering a primary control of the vehicle, posing an audible question, requiring a secondary task, and using phone calling features.

16. The method of claim 10, wherein the external assists comprise tasks requiring a responsive action on the part of the driver to converse with third parties for assistance or intervention, in an attempt by communications with the driver either to reduce the detected level of the condition of driver drowsiness or to intercede in a driving activity.

17. A system comprising:
at least one processor; and
at least one computer-readable storage device comprising instructions that when executed causes performance of a method for providing countermeasures for driver drowsiness, the method comprising:
determining, using information provided by one or more sensors of a vehicle, a level exceeding a threshold for a condition associated with driver drowsiness wherein the information provided by the sensors is at least of driver performance, vigilance, judgement or alertness with respect to vehicle operations; and
responding to the condition associated with driver drowsiness by providing a plurality of countermeasures to at least facilitate reducing the level below the threshold for the condition of driver drowsiness wherein: the countermeasures comprise a plurality of passive, interactive, and external vehicle assists for reducing a detected level of the condition of the driver drowsiness.

18. The system of claim 17, wherein in a next responding step: the method further comprises:
escalating by responding, if the level either increases or is not reduced of the condition associated with the drowsiness of the driver by selecting another assist or a combination of assists from the plurality of assists according to a particular scheme.

19. The system of claim 18, wherein the step of selecting further comprises:
selecting, in conjunction with context sensing and monitoring information derived from the sensors of vehicle, additional assists from the plurality of assists for reducing the condition associated with the drowsiness of the driver.

20. The system of claim 17, wherein the passive assists further comprise demands not requiring a responsive action on the part of the driver in an attempt to reduce the level of the condition of driver drowsiness.
